(19) United States
(12) Patent Application Publication
(10) Pub. No.: US 2014/0340030 A1
(43) Pub. Date: Nov. 20, 2014

(54) MAGNETIC SHEET AND NONCONTACT CHARGING SYSTEM USING THE SAME

(71) Applicant: SAMSUNG ELECTRO-MECHANICS CO., LTD., Suwon-si (KR)

(72) Inventors: Chang Ryul JUNG, Suwon-si (KR); Sung Yong AN, Suwon-si (KR)

(73) Assignee: SAMSUNG ELECTRO-MECHANICS CO., LTD., Suwon-si (KR)

(21) Appl. No.: 14/276,553

(22) Filed: May 13, 2014

(30) Foreign Application Priority Data
May 14, 2013 (KR) 10-2013-0054325

(51) Int. Cl. H01F 7/02; H02J 7/02

(52) U.S. Cl. CPC H01F 7/02; H02J 7/025
USPC 320/108; 335/302

(57) ABSTRACT

Disclosed herein is a magnetic sheet, including: a plate-shaped magnetic member made of a magnetic material; and a dielectric layer installed in the magnetic member to thereby shield magnetic flux generated in a thickness direction of the magnetic member, in order to provide a noncontact charging system having excellent charging efficiency.

### CROSS REFERENCE(S) TO RELATED APPLICATIONS

This application claims the benefit under 35 U.S.C. Section 119 of Korean Patent Application Serial No. 10-2013-0054325, entitled “Magnetic Sheet and Noncontact Charging System Using the Same” filed on May 14, 2013, which is hereby incorporated by reference in its entirety into this application.

### BACKGROUND OF THE INVENTION

1. Technical Field

The present invention relates to a magnetic sheet and a noncontact charging system using the same, and more particularly, to a magnetic sheet having a dielectric layer installed therein and a noncontact charging system using the same.

2. Description of the Related Art

Various electronic devices such as a mobile telephone, a video camera (a handy camera, or the like), a note-book, the latest tablet PC, and the like may be used without connecting to a socket by mounting a secondary battery on a main body of the electronic device, such that portability and convenience have been significantly improved. However, since this secondary battery has a limitation in capacity, it should be charged at least one time every several days to several weeks.

In general, examples of a charging scheme include a contact charging scheme and a noncontact charging scheme. The contact charging scheme is a scheme for performing the charging by directly contacting between an electrode of a power reception apparatus (i.e., the electronic device) and an electrode of a power supply apparatus. Since this contact charging scheme has a simple apparatus structure, this scheme has been generally used in wide applications.

Recently, however, in accordance with miniaturization and lightness of the electronic device, contact pressure between the electrode of the power reception apparatus and the electrode of the power supply apparatus is not enough, thereby causing charging defect (charging error) or the like. In addition, since the secondary battery is vulnerable to heat, there is a need to prevent an increase in temperature of the battery and circuits should be carefully designed so as not to cause over-discharging and over-charging. In order to cope with this problem, the noncontact charging scheme has been recently studied.

The noncontact charging scheme is a charging scheme using electromagnetic induction by installing coils at both of the power reception apparatus and the power supply apparatus. Since this type of charging scheme is noncontact, there is no need to consider the contact pressure between the electrodes of two apparatuses. In addition, since the contact pressure is not considered, a stable charging voltage may be supplied regardless of a contact state between the electrodes of the apparatus.

An example of the noncontact charging system has been disclosed in Korean Patent Laid-Open Publication No. 2010-0130480. Describing this example, it may be appreciated that a magnetic sheet is disposed between the secondary battery and a spiral coil in order to enhance an electromagnetic coupling between first and second coils.

As such, the noncontact charging system recently includes the magnetic sheet as an essential component, wherein as the magnetic sheet has a thicker thickness, effect is further increased, accordingly and charging efficiency of the noncontact charging system is improved.

However, as the magnetic sheet has the thick thickness, it is difficult to implement the miniaturization and thinness of a product. Therefore, a technology capable of implementing the miniaturization and thinness of the product while performing performance improvement by the magnetic sheet has been gradually required.

### RELATED ART DOCUMENT

### Patent Document

(Patent Document 1) Korean Patent Laid-Open Publication No. 2010-0130480

### SUMMARY OF THE INVENTION

As such, performance improvement of a noncontact charging system according to a thickness of a magnetic sheet and an increase in a size of a product have a trade-off relationship to each other. An object of the present invention is to provide a magnetic sheet capable of implementing miniaturization of a product while improving performance of a noncontact charging system and the noncontact charging system using the same.

According to an exemplary embodiment of the present invention, there is provided a magnetic sheet, including: a plate-shaped magnetic member made of a magnetic material; and a dielectric layer installed in the magnetic member to thereby shield magnetic flux generated in a thickness direction of the magnetic member.

The dielectric layer may have the same area as the magnetic member.

The dielectric layer may be configured of a duplex layer structure of two or more layers.

The dielectric layer may have a discontinuous pattern.

The dielectric layer may be configured of a duplex layer structure of two or more layers, the dielectric layer of each layer having a discontinuous pattern.

A pattern of the dielectric of a lower layer may be disposed so as to correspond to an interval between patterns of the dielectric layer of an upper layer.

The dielectric layer may be made of at least one material selected from a group consisting of Al₂O₃, SiO₂, TiO₂, ZnO, In₂O₃, NiO, CoO, SnO₂, ZrO₂, CuO, MgO, AlN, BN and SiC, or a compound thereof.

The magnetic member may be formed by laminating a plurality of magnetic layers.

The magnetic layer may be made of ferrite.

The magnetic layer may be made of a mixture of soft magnetic metal powder and resin.

The dielectric layer may be disposed on any layer in the magnetic member formed by laminating the plurality of magnetic layers.

A ratio a/b of a thickness a of the magnetic sheet to a thickness b of the dielectric layer may be 12.5% to 25.7%.

According to another exemplary embodiment of the present invention, there is provided a noncontact charging system, including: a wireless power transmitting apparatus forming magnetic field through a primary coil included therein at the time of applying an alternating current (AC) voltage; and a wireless power receiving apparatus generating electromotive force induced from the primary coil at a secondary coil included therein to thereby charge a battery cell, wherein the magnetic sheet as described above is disposed between the battery cell and the secondary coil.

### BRIEF DESCRIPTION OF THE DRAWINGS

FIG. 1 is an appearance perspective view of a noncontact charging system according to an exemplary embodiment of the present invention;

FIG. 2 is an exploded cross-sectional view of a main internal configuration of FIG. 1;

FIG. 3 is an enlarged perspective view of a magnetic sheet included in the exemplary embodiment of the present invention;

FIG. 4 is a cross-sectional view of FIG. 3;

FIG. 5A is a view showing a magnetic flux flow in a magnetic sheet according to the related art;

FIG. 5B is a view showing an eddy current flow due to leakage magnetic flux;

FIG. 6 is a view showing magnetic flux flow in a magnetic sheet according to an exemplary embodiment of the present invention; and

FIGS. 7 to 9 are cross-sectional views of a magnetic sheet according to another exemplary embodiment of the present invention.

### DESCRIPTION OF THE PREFERRED EMBODIMENTS

Various advantages and features of the present invention and technologies accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. Components, steps, operations, and/or elements stated herein do not exclude the existence or addition of one or more other components, steps, operations and/or elements.

Hereinafter, a configuration and an acting effect of exemplary embodiments of the present invention will be described in more detail with reference to the accompanying drawings.

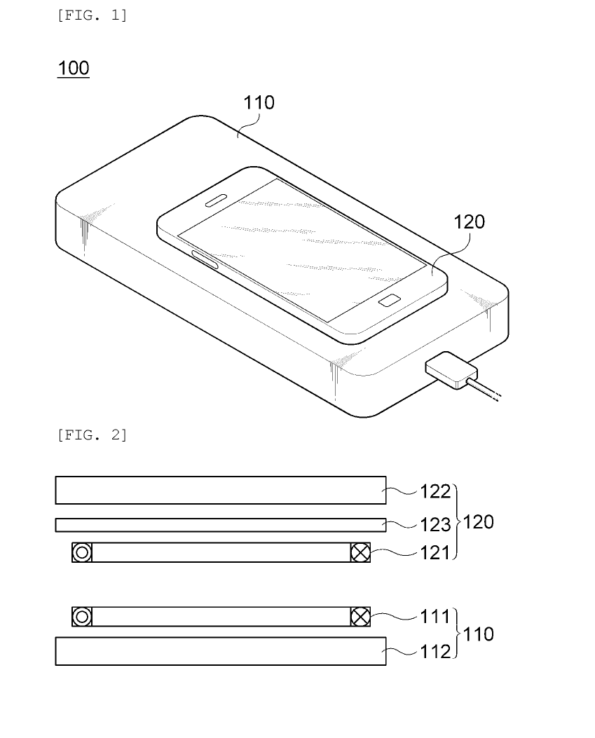

FIG. 1 is an appearance perspective view of a noncontact charging system according to an exemplary embodiment of the present invention and FIG. 2 is an exploded cross-sectional view of a main internal configuration of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention.

Referring to FIGS. 1 and 2, a noncontact charging system 100 according to an exemplary embodiment of the present invention may be configured of a wireless power transmitting apparatus 110 and a wireless power receiving apparatus 120.

The wireless power transmitting apparatus 110 is an apparatus generating magnetic field therearound and the wireless power receiving apparatus 120 is an apparatus performing power charging using a magnetic induction scheme through the magnetic field, where the wireless power receiving apparatus 120 may be a mobile phone, for example, and may be alternatively implemented as an electronic device in various forms such as a video camera, a note-book, a tablet PC, and the like.

Describing an inner portion of the wireless power transmitting apparatus 110, a primary coil 111 is formed on a substrate 112, such that when an alternating current (AC) voltage is applied to the wireless power transmitting apparatus 110, the magnetic field is formed therearound. Therefore, electromotive force induced from the primary coil 111 is generated at a secondary coil 121 embedded in the wireless power receiving apparatus 120, such that a battery cell 122 may be charged.

The battery cell 122 may be a chargeable and dischargeable nickel-hydride battery or a lithium-ion battery, but is not limited thereto. In addition, the battery cell 122 is configured separately from the wireless power receiving apparatus 120, such that it may be implemented in a detachable type capable of attaching to and detaching from the wireless power receiving apparatus 120. Alternatively, the battery cell 122 may be implemented in an integral type in which the battery cell 122 and the wireless power receiving apparatus 120 are integrally configured.

First and second coils 111 and 121 electromagnetically coupled to each other are coils around which a metal wire such as copper is wound, where the winding may have a shape such as a circular shape, an oval shape, a rectangular shape, a diamond shape, and the like, and the entire size, a number of winding, and the like may be properly controlled and set according to required characteristics.

The magnetic sheet 123 may be disposed between the secondary coil 121 and the battery cell 122.

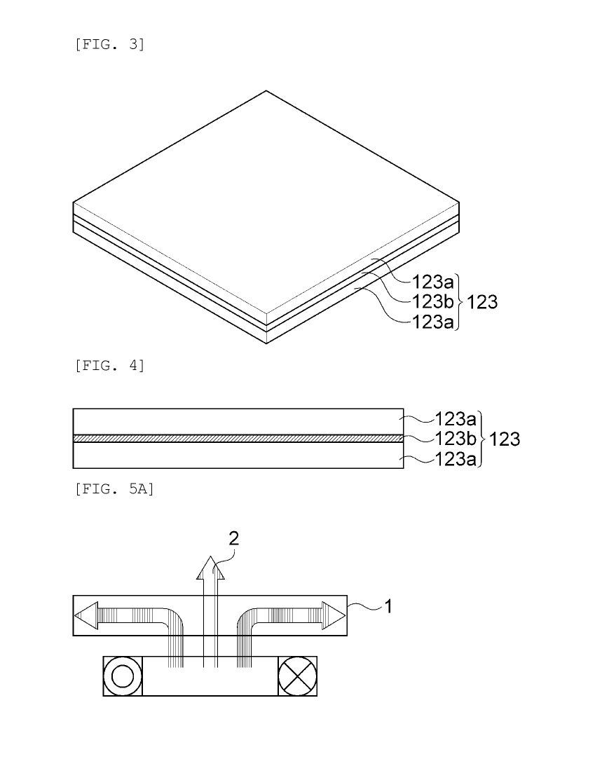

FIG. 3 is an enlarged perspective view of only the magnetic sheet 123 and FIG. 4 is a cross-sectional view of FIG. 3. Referring to FIGS. 3 and 4, the magnetic sheet 123 may be configured of plate-shaped magnetic members 123a and a dielectric layer 123b.

The magnetic member 123a is made of a material having high magnetic permeability and specifically, may be formed by laminating a plurality of magnetic layers made of ferrite material (for example, Mn—Zn based, Ni—Zn based, Ni—Zn—Cu based, or like) or a plurality of magnetic layers made of a mixture of soft magnetic metal powder (for example, Fe—Si—Al based, Fe—Si—Cr based, or the like) and resin.

As such, as the magnetic member 123a having high magnetic permeability is formed in a plate-shape, the magnetic field coupled by the first and second coils 111 and 121 flows in a length direction of the magnetic sheet 123 in the magnetic sheet 123 while having enhanced magnetic flux. That is, the magnetic member 123a serves as a conducting wire in which the magnetic flux flows, thereby increasing inductance of the coil.

The present invention is characterized in that the dielectric layer 123b is installed between the magnetic members 123a performing the above-mentioned function in the magnetic sheet 123.

Here, the dielectric layer 123b may be made of at least one material selected from a group consisting of Al₂O₃, SiO₂, TiO₂, ZnO, In₂O₃, NiO, CoO, SnO₂, ZrO₂, CuO, MgO, AlN, BN and SiC, or a compound thereof.

FIG. 5A is a view showing a magnetic flux flow in a magnetic sheet 1 according to the related art having no a dielectric layer. Referring to FIG. 5A, although the magnetic sheet 1 according to the related art is made of a magnetic material having high magnetic permeability, leakage magnetic flux 2 is generated in a vertical direction, that is, a thickness direction of the magnetic sheet 1 due to a thickness limitation of the magnetic sheet 1 and as the thickness of the magnetic sheet 1 is thinner, an amount of the leakage magnetic flux 2 is increased.

FIG. 5B is a view showing an eddy current flow due to the leakage magnetic flux 2. As shown in FIG. 5B, when the leakage magnetic flux 2 is generated as described above, the eddy current 3 caused by the leakage magnetic flux 2 flows on a main surface of the magnetic sheet 123 and a cross section area on which the eddy current 3 flows is formed widely, such that current loss is largely increased.

However, in a case of the magnetic sheet 123 of the exemplary embodiment of the present invention, since the dielectric layer 123b is formed in the length direction of the magnetic sheet 123, the leakage magnetic flux formed in the thickness direction of the magnetic sheet 123 may be shielded.

FIG. 6 is a view showing magnetic flux flow in a magnetic sheet 123 according to an exemplary embodiment of the present invention. Referring to FIG. 6, it may be confirmed that the magnetic field around the magnetic sheet 123 flows while having the enhanced magnetic flux flow in the length direction within the magnetic sheet 123 and does not penetrate the magnetic sheet 123 since the leakage magnetic flux is shielded by the dielectric layer 123b in the thickness direction. Therefore, in a case of the noncontact charging system 100 according to the exemplary embodiment of the present invention using the above-mentioned magnetic sheet 123, the current loss caused by the eddy current may be prevented, thereby making it possible to significantly improve charging efficiency.

Although the above drawing illustrates that the dielectric layer 123b is disposed between the magnetic members 123a, the dielectric layer 123b may be disposed on any layer in the magnetic member 123a formed by laminating the plurality of magnetic layers.

In addition, as the dielectric layer 123b has the thicker thickness, shielding performance is further improved, but in the case in which the dielectric layer 123b is formed with a too thick thickness, content ratio of the magnetic material in the magnetic sheet 123 having the limited thickness is decreased. Therefore, the thickness of the dielectric layer 123b may be set in an appropriate range in consideration of the overall thickness of the magnetic sheet 123.

Specifically, a ratio a/b of the thickness a of the magnetic sheet 123 to the thickness b of the dielectric layer 123b may be set in a range of 12.5% to 25.7%. The reason is that in the case in which the ratio is less than 12.5%, the thickness of the magnetic layer is too thin, such that it is difficult to produce the effect of the dielectric layer 123b and in the case in which the ratio is 25.7% or more, the effect due to the magnetic sheet 123 is decreased.

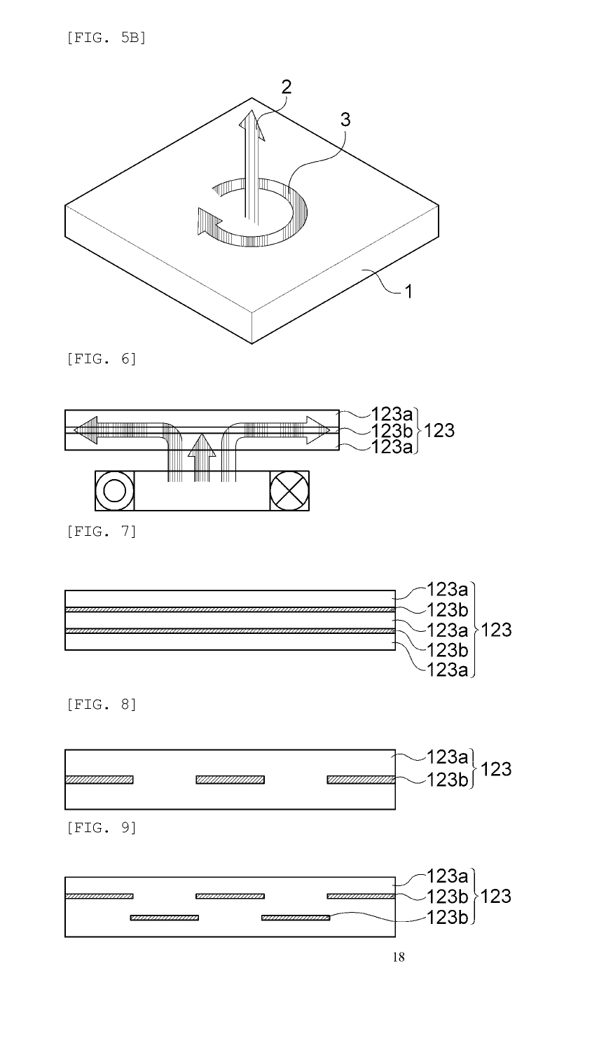

In addition, in order to more certainly shield the leakage magnetic flux, the dielectric layer 123b may be formed in a duplex structure in another embodiment of the present invention, as shown in FIG. 7. However, similar to the thickness of the dielectric layer 123b, as the number of layers of the dielectric layer 123b excessively increases, the content ratio of the magnetic material in the magnetic sheet 123 having the limited thickness is decreased. Therefore, the number of layers of the dielectric layer 123b may be appropriately set in consideration of the entire thickness of the magnetic sheet 123.

Meanwhile, although FIGS. 3 and 4 have illustrated the dielectric layer 123b having the same area as the magnetic member 123a, this case blocks a magnetic passage in the dielectric layer 123b, thereby adversely affecting a circulation of the magnetic flux. Therefore, the dielectric layer 123b may be formed to have a discontinuous pattern in another embodiment of the present invention, as shown in FIG. 8.

This discontinuous pattern intrudes the magnetic member 123a material having high magnetic permeability between the patterns so that the magnetic flux is more smoothly circulated. Here, an interval between the patterns may be randomly set.

The dielectric layer 123b having the above-mentioned discontinuous pattern may also be applied to the duplex structure as shown in FIG. 9. In this case, the patterns of the dielectric layers of upper and lower layers may be disposed in a zig-zag shape. The pattern of the dielectric layer of the lower layer may be disposed so as to correspond to an interval between the patterns of the dielectric layer of the upper layer. Here, a phrase “correspond to” may be used as a concept including a concept that the interval between the patterns of the dielectric layer of the upper layer completely coincides with a length of the pattern of the dielectric layer of the lower layer, as well as a concept that any one of the above-mentioned interval and length is slightly longer or shorter.

In the case in which the patterns of the electric layers are disposed as described above, when the patterns of the dielectric layer of the lower layer shield the leakage magnetic flux in the thickness direction, the patterns of the dielectric layer of the upper layer shield portions which are not shielded due to a discontinuous form of the patterns of the dielectric layer of the lower layer, thereby making it possible to doubly shield the leakage magnetic flux in the thickness direction and to more smoothly circulate the magnetic flux flow between the patterns.

According to the exemplary embodiment of the present invention, the dielectric layer shielding the leakage magnetic flux is installed in the magnetic sheet, thereby making it possible to prevent the generation of the eddy current due to the leakage magnetic flux, and the magnetic sheet is used as one component of the noncontact charging system, thereby making it possible to implement the miniaturization of the product and to significantly improve the charging efficiency.

The present invention has been described in connection with what is presently considered to be practical exemplary embodiments. Although the exemplary embodiments of the present invention have been described, the present invention may also be used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A magnetic sheet, comprising:
a plate-shaped magnetic member made of a magnetic material; and
a dielectric layer installed in the magnetic member to thereby shield magnetic flux generated in a thickness direction of the magnetic member.

2. The magnetic sheet according to claim 1, wherein the dielectric layer has the same area as the magnetic member.

3. The magnetic sheet according to claim 1, wherein the dielectric layer is configured of a duplex layer structure of two or more layers.

4. The magnetic sheet according to claim 1, wherein the dielectric layer has a discontinuous pattern.

5. The magnetic sheet according to claim 1, wherein the dielectric layer is configured of a duplex layer structure of two or more layers, the dielectric layer of each layer having a discontinuous pattern.

6. The magnetic sheet according to claim 5, wherein a pattern of the dielectric of a lower layer is disposed so as to correspond to an interval between patterns of the dielectric layer of an upper layer.

7. The magnetic sheet according to claim 1, wherein the dielectric layer is made of at least one material selected from a group consisting of Al₂O₃, SiO₂, TiO₂, ZnO, In₂O₃, NiO, CoO, SnO₂, ZrO₂, CuO, MgO, AlN, BN and SiC, or a compound thereof.

8. The magnetic sheet according to claim 1, wherein the magnetic member is formed by laminating a plurality of magnetic layers.

9. The magnetic sheet according to claim 8, wherein the magnetic layer is made of ferrite.

10. The magnetic sheet according to claim 8, wherein the magnetic layer is made of a mixture of soft magnetic metal powder and resin.

11. The magnetic sheet according to claim 8, wherein the dielectric layer is disposed on any layer in the magnetic member formed by laminating the plurality of magnetic layers.

12. The magnetic sheet according to claim 1, wherein a ratio a/b of a thickness a of the magnetic sheet to a thickness b of the dielectric layer is 12.5% to 25.7%.

13. A noncontact charging system, comprising:
a wireless power transmitting apparatus forming magnetic field through a primary coil included therein at the time of applying an alternating current (AC) voltage; and
a wireless power receiving apparatus generating electromotive force induced from the primary coil at a secondary coil included therein to thereby charge a battery cell,
wherein the magnetic sheet according to any one of claims 1 to 12 is disposed between the battery cell and the secondary coil.
